(19) United States
(12) Patent Application Publication
(10) Pub. No.: US 2015/0115571 A1
(43) Pub. Date: Apr. 30, 2015

(54) SMART TOW

(71) Applicant: GM GLOBAL TECHNOLOGY OPERATIONS LLC, Detroit, MI (US)

(72) Inventors: Wende Zhang, Troy, MI (US); James N. Nickolaou, Clarkston, MI (US); Ryan M. Frakes, Bloomfield Hills, MI (US)

(21) Appl. No.: 14/476,345

(22) Filed: Sep. 3, 2014

Related U.S. Application Data
(60) Provisional application No. 61/895,158, filed on Oct. 24, 2013.

(51) Int. Cl. B60D 1/36; B60R 1/00; H04N 7/18; B60D 1/06

(52) U.S. Cl. CPC B60D 1/36; B60D 1/06; B60R 1/00; H04N 7/183
USPC 280/477

(57) ABSTRACT

A system and method for providing visual assistance through a graphic overlay super-imposed on a back-up camera image for assisting a vehicle operator when backing up a vehicle to align a tow ball with a trailer tongue. The method includes providing camera modeling to correlate the camera image in vehicle coordinates to world coordinates, where the camera modeling provides the graphic overlay to include a tow line having a height in the camera image that is determined by an estimated height of the trailer tongue. The method also includes providing vehicle dynamic modeling for identifying the motion of the vehicle as it moves around a center of rotation. The method then predicts the path of the vehicle as it is being steered including calculating the center of rotation.

### CROSS-REFERENCE TO RELATED APPLICATIONS

This application claims the benefit of the priority date of U.S. Provisional Patent Application Ser. No. 61/895,158, titled, Smart Tow, filed Oct. 24, 2013.

### BACKGROUND OF THE INVENTION

1. Field of the Invention

This invention relates generally to a system and method for providing visual assistance and feedback for aligning a tow hitch ball and a trailer tongue and, more particularly, to a system and method for providing visual assistance and feedback for aligning a tow hitch ball and a trailer tongue when backing up the towing vehicle to the towed vehicle that includes providing a raised alignment line that is part of a graphic overlay in a rear-view camera image.

2. Discussion of the Related Art

Some vehicles are equipped with a tow hitch that allows a trailer or other towed vehicle to be coupled thereto so that the towing vehicle can tow the trailer. Generally, the trailer hitch is mounted to a rear support structure of the towing vehicle proximate the vehicle's rear bumper, and includes a hitch ball having a certain diameter. The towed vehicle typically includes a trailer tongue that extends from a front end of the towed vehicle. The trailer tongue often includes a cup in which the hitch ball is positioned to couple the hitch to the trailer tongue. A securing mechanism within the cup, such as a metal flap, is selectively positioned around the ball when it is inserted in the cup to securely hold the tongue to the hitch.

When the towed vehicle is detached from the towing vehicle, the trailer tongue is generally supported on an adjustable stand so that the cup is positioned higher above the ground than the ball of the hitch. When the operator of the towing vehicle attaches the tongue to the hitch, he will back up the towing vehicle to position the hitch ball just below the cup. Once in this position, the tongue is lowered onto the ball by lowering the stand.

Generally it takes a significant amount of experience and skill for the vehicle operator to accurately position the hitch ball below the tongue cup when backing up the towing vehicle to connect the towed vehicle to the towing vehicle. Regardless of the operator's skill and experience, it is nearly impossible to exactly position the hitch ball at the proper location. Therefore, the operator typically must use the trailer tongue to manually move the towed vehicle in a right or left or front or back direction to provide the exact alignment. Because the towed vehicle may be large, heavy and cumbersome to move, this is sometimes a difficult task.

Modern vehicles often include one or more cameras that provide back-up assistance, provide images of the road as the vehicle is traveling for collision avoidance purposes, provide structure recognition, such as roadway signs, etc. Camera systems used for back-up assistance often employ visual overlay graphics that are super-imposed or over-laid on the camera image to provide vehicle back-up steering guidance. For those applications where graphics are overlaid on the camera images, it is critical to accurately calibrate the position and orientation of the camera with respect to the vehicle. Camera calibration typically involves determining a set of parameters that relate camera image coordinates to vehicle coordinates and vice versa. Some camera parameters, such as camera focal length, optical center, etc., are stable, while other parameters, such as camera orientation and position, are not. For example, the height of the camera depends on the load of the vehicle, which will change from time to time. This change can cause overlaid graphics of vehicle trajectory on the camera image to be inaccurate.

It is known in the art to provide a center line in the overlay graphics super-imposed on a back-up camera image that identifies a center path for the vehicle operator to follow. However, the known back-up assistance overlay graphics are super-imposed on the ground and as such do not provide adequate visual alignment for a trailer tongue that will be significantly above the ground level.

### SUMMARY OF THE INVENTION

This disclosure describes a system and method for providing visual assistance through a graphic overlay super-imposed on a back-up camera image for assisting a vehicle operator when backing up a vehicle to align a tow ball with a trailer tongue. The method includes providing camera modeling to correlate the camera image in vehicle coordinates to world coordinates, where the camera modeling provides the graphic overlay to include a tow line having a height in the camera image that is determined by an estimated height of the trailer tongue. The method also includes providing vehicle dynamic modeling for identifying the motion of the vehicle as it moves around a center of rotation. The method then predicts the path of the vehicle as it is being steered including calculating the center of rotation.

Additional features of the present invention will become apparent from the following description and appended claims, taken in conjunction with the accompanying drawings.

### BRIEF DESCRIPTION OF THE DRAWINGS

FIG. 1 is an illustration of a camera image showing a vehicle including a tow hitch backing up relative to a trailer including a tow tongue;

FIG. 2 is an illustration showing variables for calculating a vehicle dynamic model;

FIG. 3 is an illustration showing a vehicle model coordinate system;

FIG. 4 is an illustration showing vehicle path generation in world coordinates: and

FIG. 5 is an illustration of a camera image similar to the image shown in FIG. 1 and including a flashing light source mounted to the trailer tongue.

### DETAILED DESCRIPTION OF THE EMBODIMENTS

The following discussion of the embodiments of the invention directed to a system and method for providing visual assistance and feedback to assist in vehicle tow hitch alignment through overlay graphics on a back-up camera image is merely exemplary in nature, and is in no way intended to limit the invention or its applications or uses.

The present invention proposes a back-up assistance system and method for providing visual assistance and feedback employing a graphics overlay super-imposed on a rearview camera image to assist a vehicle operator when aligning a vehicle tow hitch to a trailer tongue.

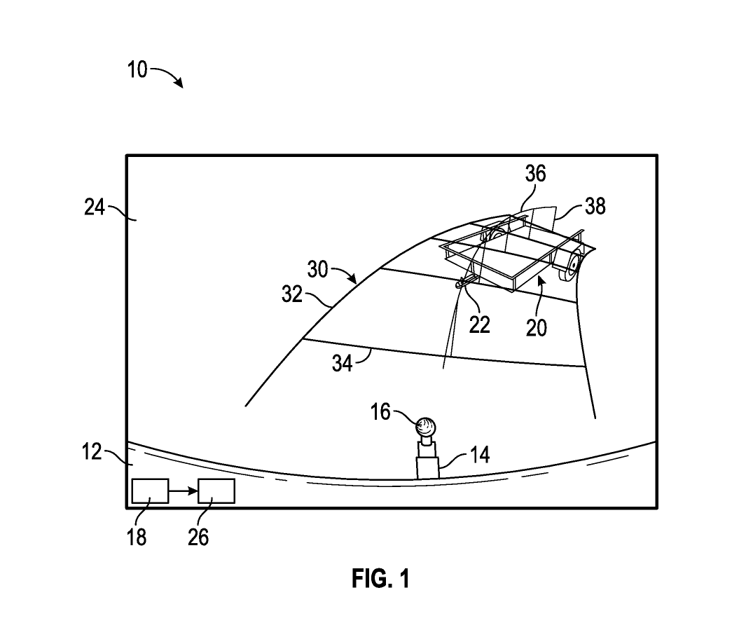

FIG. 1 is an illustration of a rearview camera image 10 from a camera mounted to a rear of a vehicle 12, where the vehicle 12 includes a tow hitch 14 having a tow ball 16 extending therefrom. A back-up assistance system 18 is shown generally on the vehicle 12 and includes all of the cameras, camera image processors, algorithms, GPS, map databases, wireless communications, autonomous vehicle controllers, CAN buses, etc. required for the invention as discussed below. Box 26 represents a display on the vehicle 12 that the image 10 can be displayed on to allow the vehicle operator to watch the image 10. The image 10 shows a trailer 20 behind the vehicle 12 and including a trailer tongue 22 positioned some distance above the ground 24 and higher than the tow ball 16.

As will be discussed in detail below, the back-up assistance system 18 provides visual feedback and hitch alignment assistance through a graphic overlay 30 on the image 10, where the graphic overlay 30 includes side bars 32 and cross bars 34 super-imposed on the ground 24 in the image 10. Additionally, the graphic overlay 30 includes a trailer hitch alignment line 36 that is overlaid in the image 10 some distance above the ground 24 that is based on an estimate of the height of the trailer tongue 22 off of the ground 24. Vertical bars 38 connected to the trailer hitch alignment line 36 and the cross bars 34 show that the trailer hitch alignment line 36 is raised off of the ground 24. As the vehicle operator turns the vehicle steering wheel, the overlay 30 rotates and moves relative to the vehicle 12 to show the current back-up path of the vehicle 12 at any one point in time. The graphic overlay 30 may also contain details about vehicle slippage after the vehicle 12 is parked if the vehicle 12 is on an incline. The basic procedures and processes necessary to super-impose a graphic overlay on a camera image are well known to those skilled in the art.

In one embodiment, the back-up assistance system 18 employs a three step process where the first step includes camera modeling to model the graphic overlay 30 provided in vehicle coordinates to world coordinates represented on the ground 24 and to properly center the overlay 30 in the image 10, where the camera may not be centered at the rear of the vehicle 12. Camera modeling for this purpose is well known to those skilled in the art and many algorithms performing such modeling are known. One suitable example can be found in U.S. patent application Ser. No. 13/843,978, titled, Wide FOV Camera Image Calibration and Dewarping, filed Mar. 15, 2013, assigned to the assignee of this application and herein incorporated by reference. Camera modeling of this type typically involves determining a set of parameters that relate camera image coordinates to vehicle coordinates and vice versa. Some camera parameters, such as camera focal length, optical center, etc., are stable, while other parameters, such as camera orientation and position, are not. For example, the height of the camera depends on the load of the vehicle, which will change from time to time. This change can cause the graphic overlay 30 of vehicle trajectory on the camera image to be inaccurate.

The next step in the process includes performing vehicle dynamic modeling to model the dynamics or motion of the vehicle 12 so that the vehicle path when the vehicle 12 is being backed up can be predicted and the overlay 30 can be accurately adjusted as the vehicle operator steers the vehicle 12 during the back-up maneuver. By employing the vehicle dynamic model, the algorithm can calculate how the vehicle 12 turns in response to the vehicle operator steering the vehicle 12 during the back-up maneuver.

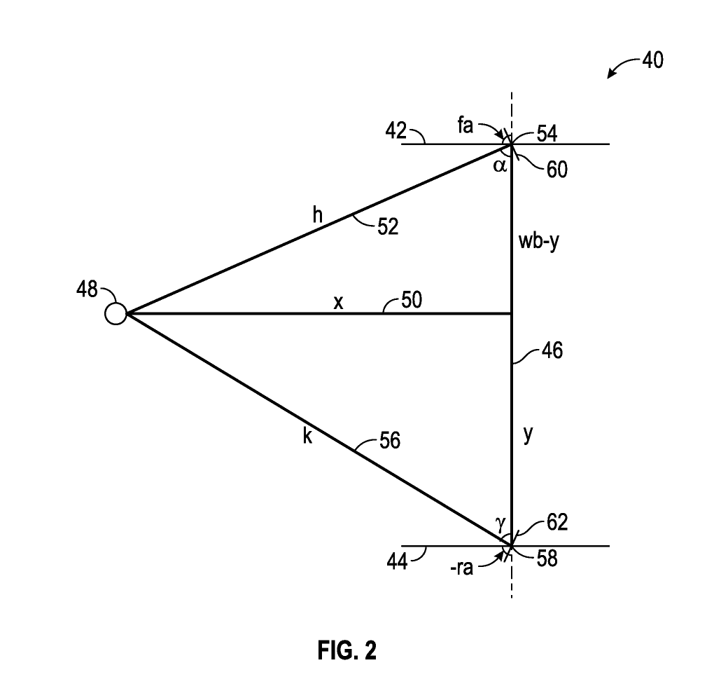

FIG. 2 is a graphical illustration 40 showing parameters employed in a bicycle model for the vehicle dynamic model that are used to calculate a center of rotation 48, where the vehicle 12 turns around the center of rotation 48 as it is being steered. The illustration 40 includes line 42 representing the vehicle front axle, line 44 representing the vehicle rear axle, and line 46 representing the vehicle wheel base wb. Line 50 is perpendicular to the line 46 and is connected to the center of rotation 48 and has a distance x, line 52 is the line through the center of rotation 48 and a front wheel location at point 54 and has a distance h, and line 56 is a line from the center of rotation 48 to a rear wheel location point 58 and has a distance k The variable fa is the angle of the front wheel represented by line 60 and variable ra is the angle of the front wheel represented by line 62. The distance between the line 50 and the line 60 is wb−y and the distance between the line 50 and the line 62 is y. The angle α is the angle between the line 52 and the line 46 and the angle γ is the angle between the line 56 and the line 46.

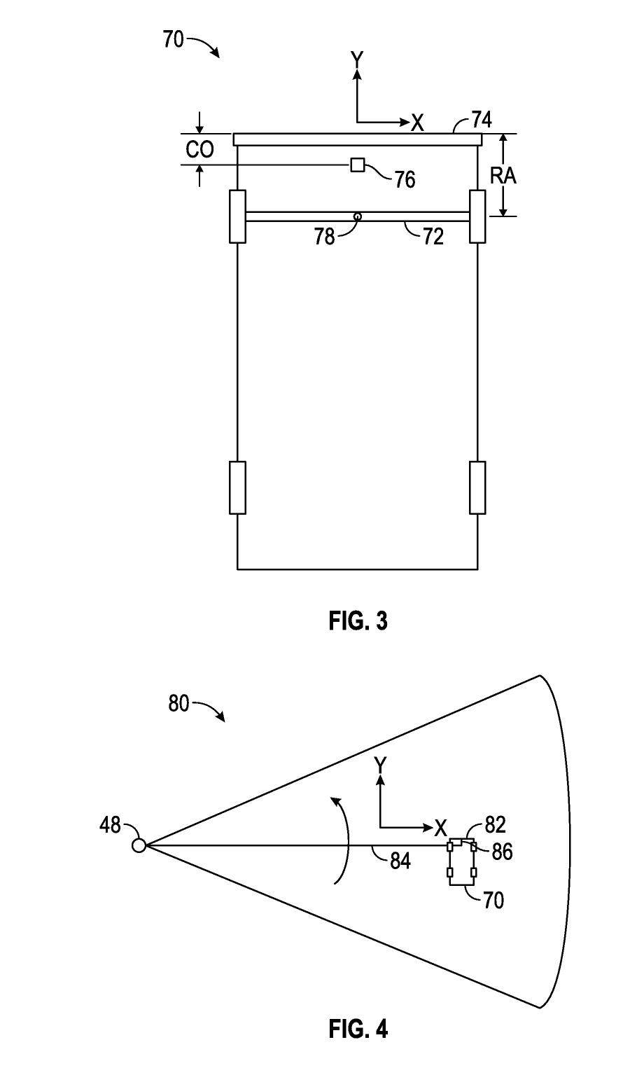

FIG. 3 is an illustration of a vehicle 70, representing the vehicle 12, to show the coordinate systems used in the vehicle model. The world coordinates are shown by an X-Y axis relative to a rear bumper 74 of the vehicle 70. A back-up camera 76 is provided on the vehicle 70 and has a camera offset CO relative to the rear of the vehicle 70. The camera 76 is shown at the center of the vehicle 70, but as will be understood by those skilled in the art, the camera 76 may be off-set from the center of the vehicle 70. Further, a rear-axle distance RA is defined between the rear of the vehicle 70 and a rear axle 72 of the vehicle 70. Point 78 is at a center of the rear axle 72 and is a reference point that relates the turn center coordinates of the vehicle 60 to the camera coordinates.

FIG. 4 is an illustration 80 showing the vehicle 70 turning around the center of rotation 48 in world coordinates. The origin of the camera coordinate system is at point 82 on the vehicle 70. Line 84 represents the X turn center xturncenter of the vehicle 70 and line 86 represents the Y turn center yturncenter of the vehicle 70 in world coordinates.

Once the vehicle 12 is modeled and the coordinate systems are correlated, the next step in the process is to predict the path of the vehicle 12 in world coordinates as it is backing up toward the trailer 20. The path generation algorithm includes calculating the center of rotation 48. This process can be described as visualizing the vehicle 70 as being attached to a rigid plate that can rotate about the center of rotation 48. The vehicle's movement is characterized as rotation of this rigid plate. Every point on the vehicle 70 will travel a circle as the plate rotates where all of the circles are concentric. The distance traveled by the vehicle 70 may be different for each point depending on the radius of the circle. The vehicle distance traveled is measured as the movement of the center of the rear bumper 74 of the vehicle 70. For any desired distance traveled, the algorithm calculates the rotation angle of the plate, where the radius equals a distance from the center of rotation 48 to the center of the rear bumper 74 and the angle of rotation equals the distance traveled divided by the radius.

For a vehicle having four-wheel steering, the following equations from the vehicle dynamic model are provided through triangulation in the illustration 40 to define and calculate the center of rotation 48.

$$\begin{matrix}y = k cos ( γ ) & ( 1 ) \\ wb - y = h cos ( α ) & ( 2 ) \\ x = k sin ( γ ) & ( 3 ) \\ x = h sin ( α ) & ( 4 ) \\ y = wb [ \frac{sin ( α ) cos ( γ )}{sin ( α ) cos ( γ ) + cos ( α ) sin ( γ )} ] & ( 5 ) \\ y = wb [ \frac{sin ( α ) cos ( γ )}{sin ( α + γ )} ] & ( 6 ) \\ α = π / 2 - fa & ( 7 ) \\ γ = π / 2 + ra & ( 8 ) \\ y = wb [ \frac{- cos ( fa ) sin ( ra )}{sin ( fa - ra )} ] & ( 9 ) \\ x = wb [ \frac{cos ( fa ) cos ( ra )}{sin ( fa - ra )} ] & ( 10 )\end{matrix}$$

For a vehicle having two-wheel steering, the following equations from the vehicle dynamic model are provided through triangulation in the illustration 40 to define and calculate the center of rotation 48.

$$\begin{matrix}y = 0 & ( 11 ) \\ x = wb \frac{cos ( fa )}{sin ( fa )} & ( 12 )\end{matrix}$$

The method for determining the vehicle path includes using the world coordinates centered at the center of rotation 48 and calculating the angle of rotation for each desired distance. The algorithm rotates the coordinate system by the angle to get new point locations, and then transforms these new locations to the original coordinates as follows.

xnew=xold*cos(t)+yold*sin(t) (13)

ynew=xold*sin(t)+yold*cos(t) (14)

The algorithm then translates the coordinates back to the coordinates centered at the back of the rear bumper 74 of the vehicle 70, which is the coordinate origin of the camera calibration as follows.

xtrans=xnew−xturncenter (15)

ytrans=ynew−yturncenter (16)

The technique discussed above calculates the vehicle path prediction so that the graphic overlay 30 moves in the image 10 in response to steering of the vehicle 12 so that the vehicle operator can watch the display 26 on the vehicle 12 and line up the alignment line 36 with the tongue 22 to better align the tow ball 16 with the tongue 22. Enhancements can be made that make it easier for the vehicle operator to position the hitch ball 16 at the proper location. For example, limitations in the vehicle operator's ability to see the tongue 22, such as in low light conditions, may hinder his ability to properly align the hitch ball 16 with the tongue 22. In an alternate embodiment, the vehicle operator will place some defined light source on the tongue 22, such as by a magnetic attachment, where the light source may be a flashing LED to identify the location of the tongue 22.

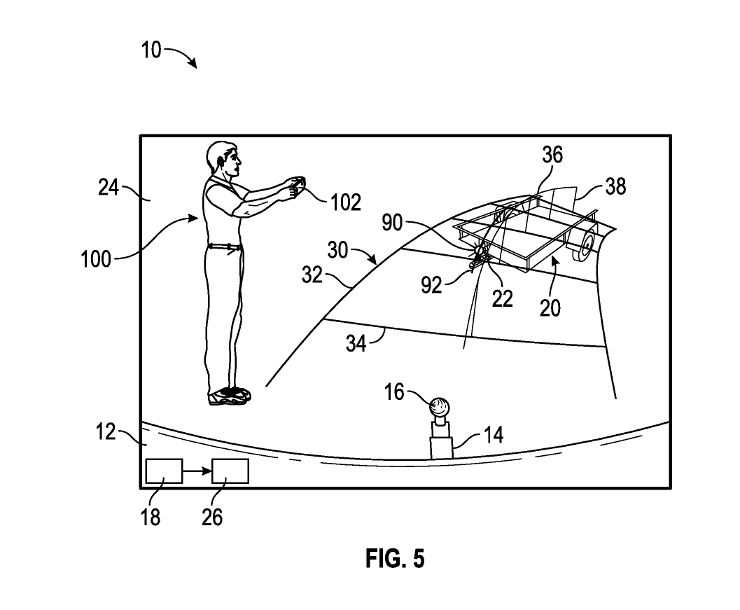

FIG. 5 is the same camera image of the vehicle 12 and the trailer 14 as shown in FIG. 1, but where the vehicle operator has placed a light source 90, such as a flashing LED, on the tongue 22. When the light source 90 is flashing, the image processing of the system 18 can detect the location of the light source 90 by suitable image processing, such as temporal differencing. Once the system 18 detects the light source 90, the graphic overlay process can generate a tow projection line 92 that is independent of the graphic overlay 30 including the alignment line 36, where the graphic overlay 30 and the tow line 92 move independent of each other as the vehicle 12 is steered because the graphic overlay 30 remains centered at the image 10, but the tow line 92 stays on the light source 92.

Once the system 18 provides the tow projection line 92 through the vehicle dynamic modeling, the algorithm can use various processes to identify the desired steering angle that causes the vehicle 12 to back up along the line 92. For example, if a brute force technique is used to identify the location of the tow projection line 92, i.e., systematically setting the tow projection line 92 every couple of degrees of angle and determining which one crosses the light source 90, the associated steering angle for the line 92 is known from that process. Once the desired steering angle is known to steer the vehicle 12 along the line 92, the algorithm calculates the difference between the current steering angle of the vehicle 12 and the desired steering angle and provides steering guidance, such as left or right flashing arrows on the display 26, to cause the vehicle operator to steer the vehicle 12 so that the difference in the steering angles becomes zero and the tow projection line 92 aligns with the hitch alignment line 36. When this happens, the tow line 92 and the hitch alignment line 36 can change color to indicate the overlap and the proper steering.

Because the hitch ball 16 is stationary and clearly visible in the image 10 and thus does not get blurred as the vehicle 12 is backing up and moving, the location of the hitch ball 16 can be accurately identified through the image processing. Thus, the relationship between the location of the hitch ball 16 and the location of the tongue 22 having the flashing LED light source 90 can be correlated so that when they are positioned relative to each other, an indication can be given to the vehicle operator to stop the vehicle 12. For example, when the hitch ball 16 is in the location of the tongue 22 in the image 10, the algorithm can provide a braking indication to the driver, such as a horn beep, visual indication, such as a color change in the graphic overlay 30, etc. to stop the vehicle 12.

The above described process of generating the hitch alignment line 36 and the tow line 92 and then providing guidance for the steering angle to align the two lines can also be performed autonomously. As is well understood by those skilled in the art, vehicle steering, throttle and braking can be automatically provided based on camera images and other detection devices on the vehicle 12. For example, cruise control systems have been on vehicles for a number of years where the vehicle operator can set a particular speed of the vehicle, and the vehicle will maintain that speed without the driver operating the throttle. Adaptive cruise control systems have been recently developed in the art where not only does the system maintain the set speed, but also will automatically slow the vehicle down in the event that a slower moving vehicle is detected in front of the subject vehicle using various sensors, such as radar, lidar and cameras. Modern vehicle control systems may also include autonomous parking where the vehicle will automatically provide the steering control for parking the vehicle, and where the control system will intervene if the driver makes harsh steering changes that may affect vehicle stability and lane centering capabilities, where the vehicle system attempts to maintain the vehicle near the center of the lane. Fully autonomous vehicles have been demonstrated that drive in simulated urban traffic up to 30 mph, while observing all of the rules of the road.

For this particular application, the vehicle operator can engage autonomous tow positioning in known ways, where the system 18 will automatically back up the vehicle 12. In the autonomous process, the system 18 detects the light source and identifies the steering angle as described above, but instead of providing steering guidance to align the alignment line 36 and the tow line 92, the system 18 provides that actual steering to obtain the desired steering angle. Further, the system 18 can autonomously apply the brakes to stop the vehicle 12 when the hitch ball 16 is at the desired location.

For the visual hitch assist or autonomous vehicle hitching processes discussed above, the system 10 can employ any suitable type of indication for the status of the process, such as visual, audible, or otherwise, to indicate the particular state of the tow hitch process for the vehicle operator. These status indicators could include audible horn beeps, feature lights, reverse lights, haptic driver seat, reverse taillight illumination, warning flashers, turn signal indicators, etc. Further, the vehicle 12 can include an incline sensor, common on many vehicles, that provides an indication that the vehicle 12 is on an incline, such as a boat ramp, which also can be a status warning to the vehicle operator during the hitching process. Such an incline detection can also be provided by GPS or a digital map data base that has prior knowledge of the slope angle of a particular area, such as a boat ramp, which may cause the vehicle 12 to roll slightly backwards until the drive shaft is engaged with a parking pall.

In a further enhancement, the vehicle operator can use a smart phone external to the vehicle 12 and provide the communications between the smart phone and the back-up system 18 through a suitable wireless communications link, such as WiFi-direct, Bluetooth, etc. This is represented by vehicle operator 100 holding a smart phone 102 in FIG. 5, where the vehicle operator 100 is external to the vehicle 12. In this embodiment, there is a wireless communications link transferring vehicle messages of vehicle dynamic states or status, such as speed, yaw rate angle, etc., between the system 18 and the smart phone 102, such as through WiFi-direct or a connection to a center stack module (CSM). The smart phone 102 will include a suitable application that is able to receive the data and information including the image 10 and the graphic overlay 30 to be displayed on the smart phone 102. The vehicle operator 100 can watch the image on the phone 102 and provide commands using the smart phone 102 to command the transmission gear state, brake state, turn the vehicle 12 to align the hitch ball 16 with the trailer tongue 22. Since the vehicle operator 100 can be standing near the hitch ball 16 he can stop the vehicle movement when the hitch ball 16 is in the proper location or engage the brakes or shift the vehicle transmission into park. If the vehicle 12 is operating autonomously, the driver 100 can watch the process on the smart phone 102 after giving the autonomous hitch command.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for aligning a tow ball on a towing vehicle with a trailer tongue on a towed vehicle in a hitching process, said method comprising:
providing camera modeling to correlate a camera image from a camera at a rear of the towing vehicle in vehicle coordinates to world coordinates, said camera modeling providing a graphic overlay super-imposed on the camera image that is in world coordinates and provides visual steering assistance, said graphic overlay including a tow line having a height in the camera image in world coordinates that is determined by an estimated height of the trailer tongue;
providing vehicle dynamic modeling for identifying the motion of the towing vehicle as the towing vehicle moves around a center of rotation; and
predicting the path of the vehicle as it is being steered including calculating the center of rotation.

2. The method according to claim 1 wherein the camera is offset from a center of the rear of the towing vehicle and wherein providing camera modeling includes correcting the camera image so that it is centered relative to the towing vehicle.

3. The method according to claim 1 wherein providing vehicle dynamic modeling includes employing triangulation.

4. The method according to claim 1 further comprising providing an indication for braking to a vehicle operator when the hitch ball is positioned at a desirable location relative to the trailer tongue.

5. The method according to claim 4 wherein the indication for braking is selected from the group consisting of a horn beep and a color change in the graphic overlay.

6. The method according to claim 1 further comprising providing a flashing light source on the trailer tongue, wherein providing camera modeling includes providing a trailer tongue projection line projected through the light source.

7. The method according to claim 6 wherein providing a trailer tongue projection line projected through the light source includes using a brute force process.

8. The method according to claim 6 further comprising defining a desired steering angle for steering the vehicle along the projection line and providing assistance for steering the vehicle from its current steering location to the desired steering angle.

9. The method according to claim 8 wherein providing assistance for steering the vehicle includes providing assistance for steering the vehicle so that the projection line and the tow line overlap.

10. The method according to claim 8 wherein providing assistance for steering the vehicle includes telling the vehicle operator which way to turn.

11. The method according to claim 8 wherein providing assistance includes automatically steering the vehicle to the desired steering angle.

12. The method according to claim 1 further comprising providing a wireless communications link between the towing vehicle and a smart phone so as to allow the vehicle operator to align the tow ball with the trailer tongue using the smart phone.

13. The method according to claim 1 wherein the towing vehicle includes an indicator that indicates that the towing vehicle is on an incline, and wherein the graphic overlay provides the indication that the towing vehicle is on the incline for possible vehicle slippage.

14. The method according to claim 13 wherein the incline indicator is selected from the group consisting of an incline sensor on the towing vehicle, GPS and a digital map database.

15. The method according to claim 1 wherein the towing vehicle includes one or more indicators identifying the state of the hitching process.

16. The method according to claim 15 wherein the state indicators are selected from the group consisting audible horn beeps, feature lights, reverse lights, haptic seat, turn signal flashers, warning flashers and tail light illumination.

17. A method for aligning a tow ball on a towing vehicle with a trailer tongue on a towed vehicle in a hitching process, said method comprising:
providing camera modeling to correlate a camera image from a camera at a rear of the towing vehicle in vehicle coordinates to world coordinates, said camera modeling providing a graphic overlay super-imposed on the camera image that is in world coordinates and provides visual steering assistance, said graphic overlay including a tow line having a height in the camera image in world coordinates that is determined by an estimated height of the trailer tongue;
providing vehicle dynamic modeling for identifying the motion of the towing vehicle as the towing vehicle moves around a center of rotation;
predicting the path of the vehicle as it is being steered including calculating the center of rotation;
providing a visual indicator on the trailer tongue, wherein providing camera modeling includes providing a trailer tongue projection line projected through the visual indicator; and
providing an indication to a vehicle operator when the hitch ball is positioned at a desirable location relative to the trailer tongue.

18. The method according to claim 17 further comprising defining a desired steering angle for steering the vehicle along the projection line and providing assistance for steering the vehicle from its current steering location to the desired steering angle.

19. The method according to claim 18 wherein providing assistance for steering the vehicle includes providing assistance for steering the vehicle so that the projection line and the tow line overlap.

20. The method according to claim 17 wherein the camera is offset from a center of the rear of the towing vehicle and wherein providing camera modeling includes correcting the camera image so that it is centered relative to the towing vehicle.

21. A system for aligning a tow ball on a towing vehicle with a trailer tongue on a towed vehicle, said system comprising:
means for providing camera modeling to correlate a camera image from a camera at a rear of the towing vehicle in vehicle coordinates to world coordinates, said means for providing camera modeling providing a graphic overlay super-imposed on the camera image that is in world coordinates and provides visual steering assistance, said graphic overlay including a tow line having a height in the camera image in world coordinates that is determined by an estimated height of the trailer tongue;
means for providing vehicle dynamic modeling for identifying the motion of the towing vehicle as the towing vehicle moves around a center of rotation; and
means for predicting the path of the vehicle as it is being steered including calculating the center of rotation.
